(19) United States
(12) Patent Application Publication
(10) Pub. No.: US 2013/0255346 A1
(43) Pub. Date: Oct. 3, 2013

(54) METAL-STAMPING DIE MANUFACTURED BY ADDITIVE MANUFACTURING

(71) Applicants: Michael Richard Danby, Stoney Creek (CA); Jason F. Reznar, Redford, MI (US)

(72) Inventors: Michael Richard Danby, Stoney Creek (CA); Jason F. Reznar, Redford, MI (US)

(73) Assignee: A. Raymond et Cie, Grenoble (FR)

(21) Appl. No.: 13/795,495

(22) Filed: Mar. 12, 2013

Related U.S. Application Data
(60) Provisional application No. 61/617,274, filed on Mar. 29, 2012.

(51) Int. Cl. B29C 67/00; B21D 22/02

(52) U.S. Cl. CPC B29C 67/0062; B21D 22/02
USPC 72/352; 264/401

(57) ABSTRACT

A metal-stamping die or tool is provided. Another aspect uses an additive manufacturing machine and material to create a die. A further aspect provides a method of making a die from an additive manufacturing process and/or using such a die to stamp a metal part, such as a fastener or clip.

### CROSS REFERENCE TO RELATED APPLICATION

This application claims the benefit and priority of U.S. Provisional Application Ser. No. 61/617,274 filed Mar. 29, 2012, which is incorporated by reference herein.

### BACKGROUND AND SUMMARY

The present disclosure relates generally to sheet metal forming tools and more particularly to manufacturing of metal-stamping dies using additive manufacturing processes.

Stamped metal parts are typically manufactured by pressing sheet metal between upper and lower machined steel dies to form a closed cavity in the net shape of a final part. Depending on part complexity, the desired net shape may be achieved in a single stage operation or through multiple stamping stages. Accordingly, a single tool having a complex profile or multiple sets of low complexity tools may alternately be used to produce the desired net shape for the stamped part. Exemplary stamping processes are disclosed in U.S. Pat. No. 2,372,516 entitled “Machine for Forming Material” which issued to Rechton et al. on Mar. 27, 1945 and U.S. Pat. No. 7,055,353 entitled “Progressive Stamping Die” which issued to Cowie on Jun. 6, 2006. These patents are incorporated by reference herein.

Typically for low volume part manufacturing, such as in prototype processing, parts are disadvantageously manufactured with multiple, low complexity tools due to the time and cost required for tool modification at each design stage. Various processes for reducing completion time for tooling have been contemplated, such as disclosed in U.S. Pat. No. 5,658,506 entitled “Methods of Making Spray Formed Rapid Tools” which issued to White et al. on Aug. 19, 1997 and U.S. Pat. No. 5,793,015 entitled “Apparatus for Rapidly Forming Laminated Dies” which issued to Walczyk on Aug. 11, 1998. While these patents provide methods for reducing cost and time for production tooling, further reductions in timing and costs need to be realized to be effective for prototype tooling.

In accordance with the present invention, a metal-stamping die or tool is provided. Another aspect, uses an additive manufacturing machine and material to create a die. A further aspect provides a method of making a die from an additive manufacturing process and/or using such a die to stamp a metal part, such as a fastener or clip.

The present apparatus and method for making a metal-stamping die is advantageous over traditional methods. For example, the present apparatus and method advantageously merges multiple die tools into a single die configuration that would otherwise be prohibitively expensive, if not impossible, to produce as a conventional die. Furthermore, reducing the number of die tools results in a savings of thousands of dollars and many weeks of die manufacturing time. In other aspects, the present method allows for quick and inexpensive design and part revisions from one manufacturing cycle to another. In yet another aspect, the present method provides a temporary tool for use while a production tool is being built or repaired. The additive manufacturing process also creates surfaces, internal voids and other die formations that would be very difficult, if not impossible, to manufacture with conventional milling machines, electrical discharge machines (EDM), and the like. Additional advantages or features of the present invention can be found in the following description and appended claims as well as in the accompanying drawings.

### BRIEF DESCRIPTION OF THE DRAWINGS

FIG. 1 is a perspective view showing a trim clip formed in tooling in accordance with the present invention;

FIG. 2 is a perspective view showing a laser cut blank;

FIG. 3 is a perspective view of the laser cut blank of FIG. 2 after an initial stamping operation in a first prototype tool and formed in accordance with the present invention;

FIG. 4 is a perspective view of the laser cut blank of FIG. 2 after an intermediate stamping operation in a second prototype tool and formed in accordance with the present invention;

FIGS. 5A and 5B are perspective views of the laser cut blank of FIG. 2 after a final stamping operation in a third prototype tool and formed in accordance with the present invention;

FIG. 6 is a perspective view showing a machine manufacturing a top punch of the first prototype tool, with an upper cover of the machine removed;

FIGS. 7-9 are a series of diagrammatic side views showing the machine building up the top punch of FIG. 6;

FIG. 10 is a perspective view showing an alternate machine manufacturing the top punch of the first prototype tool;

FIG. 11 is an exploded perspective view showing an embossing prototype tool formed in accordance with the present invention;

FIG. 12 is an exploded cross-sectional view, taken along line 12-12 of FIG. 11, showing the embossing prototype tool;

FIG. 13 is an exploded cross-sectional view showing a portion of the tool of FIG. 3;

FIG. 14 is a cross-sectional view showing the tool of FIG. 13, in a closed position; and

FIG. 15 is a cross-sectional view of a portion of the trim clip made in the tool of FIG. 13.

### DETAILED DESCRIPTION

A metal-stamping die, in other words a die for stamping sheet metal parts, is made by an additive manufacturing process, such as three-dimensional printing (“3DP”). The die is preferably used to stamp sheet metal fasteners, such as, but not being limited to snap-in clips.

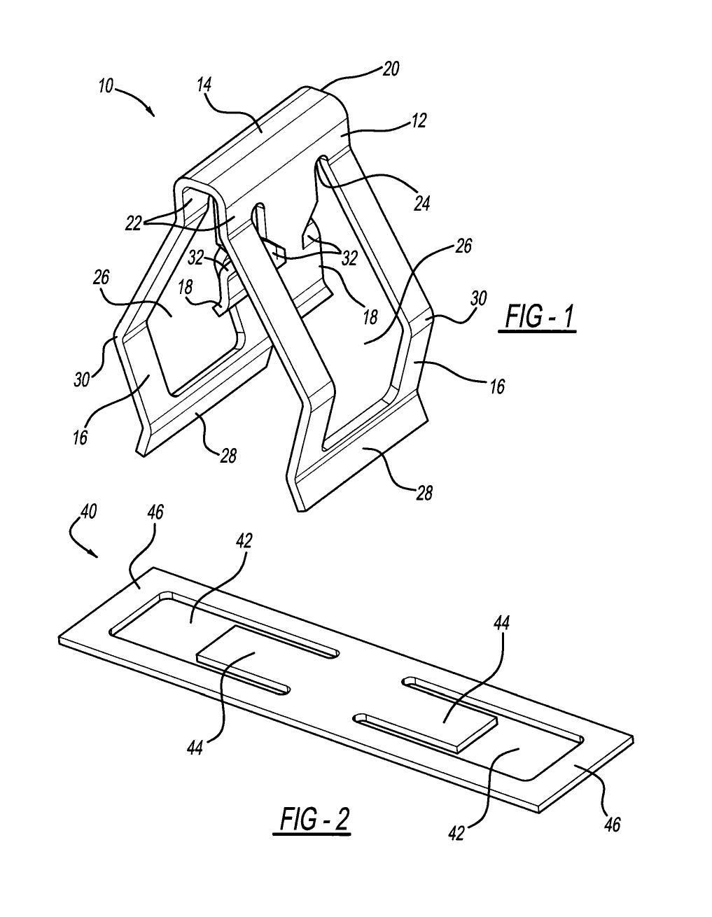

In a preferred embodiment, a part manufactured by the stamping process of the present invention is a trim fastener or clip 10, as illustrated in FIG. 1. Trim clip 10 can be employed in an automotive vehicle to connect two panels together, for example, by pushing onto a stud or clip tower in one panel and snapping into a hole in a vehicular body panel. Although the part is depicted as trim clip 10, it should be understood that a myriad of other parts can be manufactured with the stamping process and tooling of the present invention. For example, stamped parts formed with the tooling of the present invention may be employed in other industrial or residential settings, such as with solar panels, HVAC systems, wall mountings, toys, and appliances. Accordingly, trim clip 10 is preferably manufactured from a thin gage 1050-1065 steel sheet that is heat-treated, depending upon the use, but can alternately be any rigid polymeric, metallic or composite prototype part or the like formed by stamping, although some of the present advantages may not be realized.

Exemplary trim clip 10 has a generally U-shaped body 12 including a closed end 14, a pair of leg members 16 having an irregular polygonal configuration, and a pair of tabs 18 extending substantially perpendicular to the closed end 14. Closed end 14 includes a substantially flat lower wall 20 and a pair of parallel walls 22 extending perpendicularly to the lower wall 20. Parallel walls 22 are adjoined with leg members 16 and tabs 18 at a terminal end 24 opposite to the lower wall 20.

Each leg member 16 has a central slot 26 extending from the respective parallel wall 22 to an upper cross-member 28 arranged opposite closed end 14. Each leg member 16 extends from closed end 14 in an alternately divergent and convergent manner so as to form shoulders 30, which act as “snap-in wings” for interlocking a panel (not shown). Tabs 18 are sized to extend from the respective parallel wall 22 between respective leg members 16. In this way, leg members 16 are adjoined to parallel walls 22 at an outer periphery, while tabs 18 are adjoined centrally to parallel walls 22. Tabs 18 include a pair of protrusions 32 cut from tabs 18 (e.g., laser cut) and bent inwardly towards opposite tab 18.

A preferred manufacturing process for trim clip 10 will now be described with reference to FIGS. 2-5. It should be appreciated that alternate part configurations can be employed, but using the presently preferred manufacturing method, although some of the present advantages may not be achieved. The configuration of the trim clip 10, however, is ideally suited for the present die construction. As can be seen in FIG. 2, a laser cut blank 40 is provided having a pair of windows 42 corresponding to central slots 26. Laser cutting the windows 42 provides a pair of flanges 44 and a pair of bridge members 46, where each bridge member 46 defines one window 42 into which flange 44 extends. Each bridge member 46/window 42/flange 44 group extends in opposite directions from a central portion of blank 40. Although not shown in this figure, laser cut blank 40 may be further processed to form protrusions 32 from flanges 44.

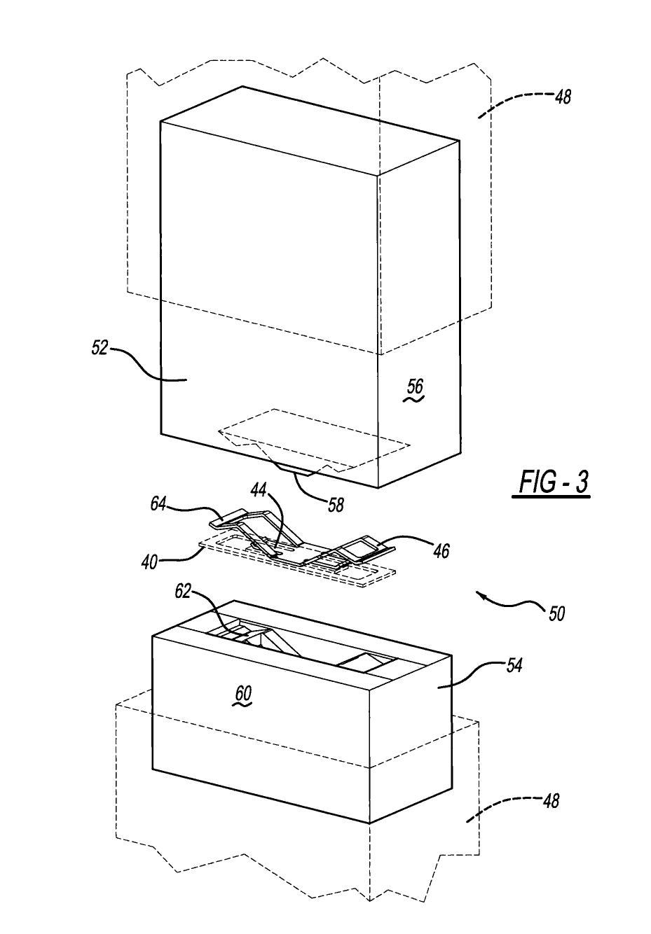

With reference now to FIG. 3, the laser cut blank 40 is inserted into a press 48 having a first prototype tool 50 including an upper die 52 and a lower die 54. Upper die 52 includes a solid clamping block 56 extending to a die face 58 having a profile corresponding to an initial bending position for laser cut blank 40. Similarly, lower die 54 has a clamping block 60 defining a corresponding die face 62 exhibiting a profile corresponding to the initial bending position for laser cut blank 40. For example, die faces 58, 62 incorporate multiple bending angles for laser cut blank 40 so as to provide profiles corresponding to near-final configurations for each bridge member 46 (corresponding to leg members 16) and for each flange 44 (corresponding to tabs 18). In order to achieve the multiple bending angles for the die faces 58, 62, the upper and lower dies 52, 54 are formed from an additive manufacturing process, as will be described in more detail below.

In operation, clamping blocks 56, 60 are chucked within jaws of press 48 so as to align die faces 58, 62. Laser cut blank 40 is placed on die face 62. Press 48 is then closed, so as to move upper die 52 towards lower die 54 and form a closed cavity for pressing laser cut blank 40 therebetween. This action of press 48 causes laser cut blank 40 to bend into the near-final configuration exhibited on die faces 58, 62 (e.g., first bend blank 64). In other words, flanges 44 and bridge members 46 are bent into their final configuration, but not yet bent into the final U-shape configuration.

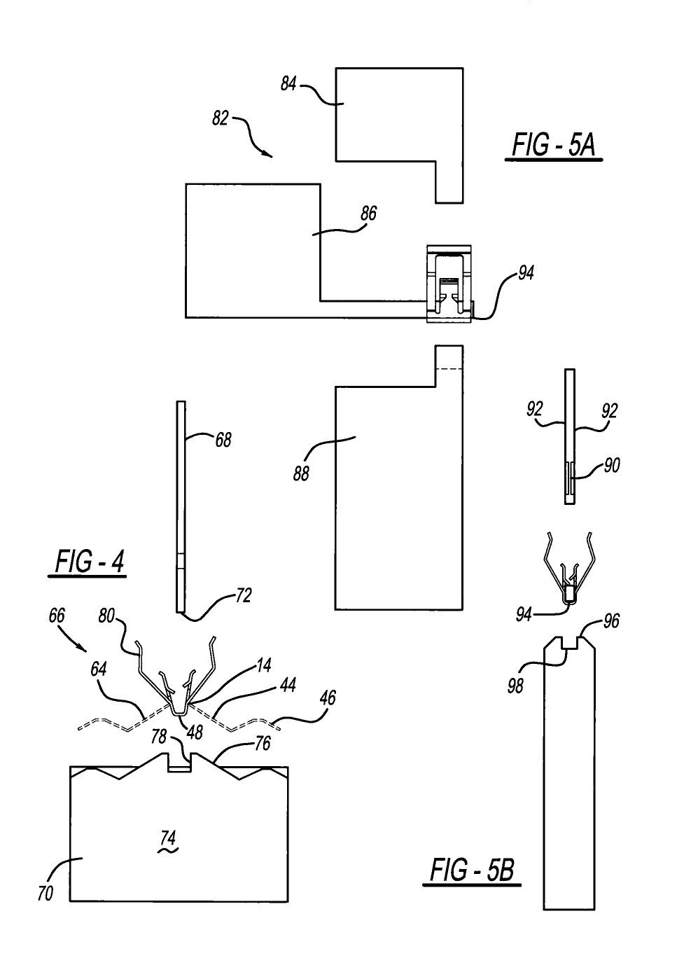

Referring now to FIG. 4, first bend blank 64 is next inserted into a second prototype tool 66 between a second upper die 68 and a second lower die 70 for completion of an intermediate bending or a “U-up” operation. Second upper die 68 is a thin-walled, straight tool having a lower die face 72 correspondingly sized with an inner surface of U-shaped closed end 14. Second lower die 70 has a clamping block 74 defining a die face 76 exhibiting a lower surface profile corresponding to the initial bending position for first bend blank 64. Second lower die 70 also includes a central channel 78 correspondingly sized with an outer surface of U-shaped closed end 14. As with upper and lower dies 52, 54, second lower die 70 is formed from an additive manufacturing process, as will be described in more detail below. Second upper die 68, however, is traditionally formed from tool steel due to its less complex nature and its thin-walled configuration. In this way, second upper die 68 is formed from a tool steel machined to the appropriate dimension and shape.

In operation, second prototype tool 66 is secured within press 48 in place of first prototype tool 50 (e.g., second lower die 70 is secured at clamping block 74) so as to align die face 72 with central channel 78. First bend blank 64 is flipped and inserted between second upper die 68 and second lower die 70 so as to lie along die face 76. Press 48 is closed, so as to move second upper die 68 towards second lower die 70. Second upper die 68 is then brought into contact with first bend blank 64 at a central position, thereby causing flanges 44 and bridge members 46 to move upwardly and inwardly towards second upper die 68 (e.g., each to approximately 85° from the unbent position). In other words, flanges 44 and bridge members 46 are bent to within 10° of the final u-shape configuration (e.g., second bend blank 80).

With reference now to FIGS. 5A and 5B, second bend blank 80 is now be inserted into a third prototype tool 82, between a third upper die 84, an intermediate die 86, and a third lower die 88 in a final bending or “closing” operation. Third upper die 84 is a thin-walled, straight tool having a notched portion 90 along opposing surfaces 92 corresponding to the location of the pair of protrusions 32 cut from tabs 18. Third intermediate die 86 is sized to fit below protrusions 32 and has a lower die face 94 correspondingly sized with an inner surface of U-shaped closed end 14. Third lower die 88 has a die face 96 including a central channel 98 also correspondingly sized with U-shaped closed end 14. Third upper die 84, intermediate die 86, and third lower die 88 are traditionally formed from tool steel due to their reduced complexity and thin-walled configurations.

In operation, third prototype tool 82 is secured within press 48 in place of second prototype tool 66. Second bend blank 80 is inserted between intermediate die 86 and third lower die 88 so as to lie within central channel 98. Press 48 is then closed, moving third upper die 84 into contact with intermediate die 86 and towards third lower die 88. Intermediate die 86 is brought into contact with second bend blank 80 at a central position, causing flanges 44 and bridge members 46 to continue inward movement to the final U-shaped configuration.

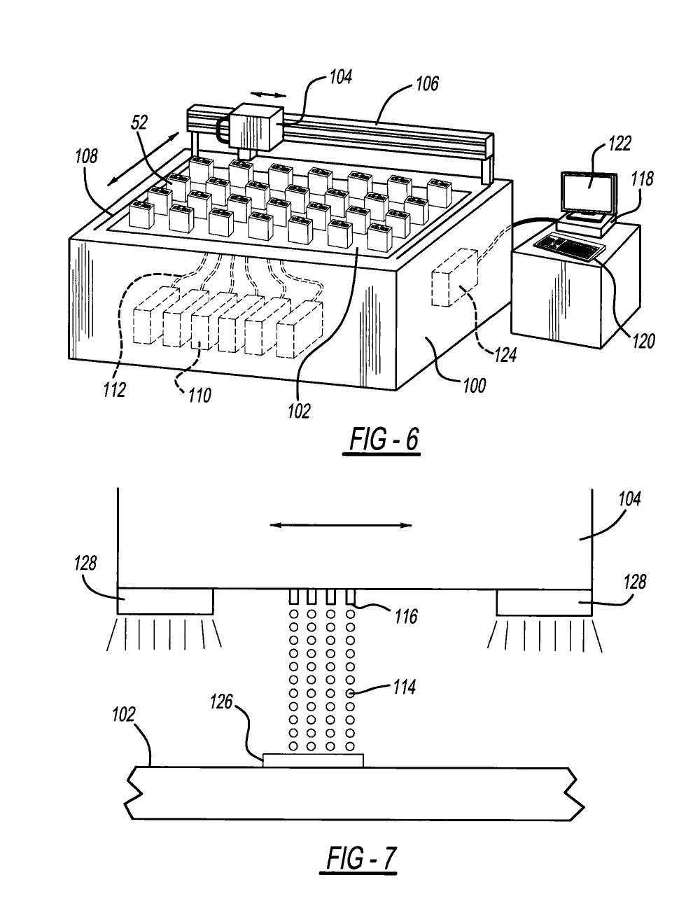

Upper die 52, lower die 54, and second lower die 70 are preferably three-dimensionally printed from a polymeric or metallic material or may alternately be formed from fused filament fabrication (FFF), selective laser sintering (SLS), electron beam melting (EBM), or direct metal laser sintered from a metallic material. The present method advantageously eliminates the traditional need for expensive progressive dies otherwise required to stamp sheet metal. A preferred 3DP machine 100 and process for forming upper die 52, lower die 54, and second lower die 70 are shown in FIGS. 6-9. The 3DP machine 100, as best shown in FIG. 6, includes a stationary support surface 102 upon which a plurality of upper dies 52 are created. Although only upper die 52 is shown being created in 3DP machine 100, it should be understood that any of the complex tooling can be created in machine 100 and by the following process (e.g., upper die 52, lower die 54, second lower die 70).

Machine 100 further includes at least one ink jet printer head 104, and preferably eight heads, which traverse side to side along one or more gantry rails 106 by an electric motor or other automatically controlled actuators. The gantry rail 106 also moves fore and aft above support surface 102 along outboard tracks 108, driven by an electric motor or other automatically controlled actuator. At least two storage tanks 110 or removable cartridges are connected to head 104 via supply hoses 112 in order to feed the same or different materials 114 contained within each tank 110 to multiple ink jet printer openings 116 in head 104. Openings 116 may constitute an array of 10×10 or even 100×100 nozzles, and more preferably 96 nozzles, arranged in a linear array such that multiple material flows are simultaneously emitted during a single head pass. The material is preferably an acrylic material having ultra-violet (UV) stabilizers (e.g., FULLCURE 720™ or VEROGRAY™ materials), but can alternately be a printed metallic material.

A computer controller 118, having an input keyboard 120, an output display screen 122, and a microprocessor (not shown), is connected to a central processing unit (CPU) 124 of machine 100 to control the feed of material from tanks 110 and the actuator movement of head 104 relative to support surface 102. The machine user downloads a CAD file containing design information for upper die 52 into non-transient computer memory, such as RAM, ROM, a hard drive, or removable storage, associated with computer controller 118. The user may then use software instructions stored in memory to digitally layout the desired quantity of upper dies 52 onto support surface 102. The user may also position the upper dies 52 in a manufacturing orientation; for example, by having clamping block 56 arranged to be created before more complex die face 58 or, in other words, having the die face 58 arranged in the +Z direction. Preferably, the user may indicate that the tooling (e.g., upper dies 52) be built in high quality mode with a glossy finish to provide a high resolution tool. The user also inputs the material(s) to be used in the manufacturing, whereafter the microprocessor in computer controller 118 and CPU 124 runs software to cause head 104 to begin its movement and material deposition in order to create upper dies 52.

During a first transverse pass of head 104, as shown in FIG. 7, ink jet printing openings 116 emit streams of material 114 and lay down a first layer 126, constituting a bottom external surface of clamping block 56. This first pass can lay down a material thickness of approximately 0.1-1.0 mm of upper die 52. As head 104 continues in its transverse path, it will lay down the same exact material layer for each adjacent upper die 52 being manufactured in the same manufacturing cycle. Alternately, if the array of openings 116 is large enough, spread out or contained on multiple heads, then multiple upper dies 52 may be simultaneously formed. One or more ultra violet lights 128 are attached to head 104 which serve to emit light onto the layered material immediately after its deposition, thereby binding together and curing each layer of material being deposited.

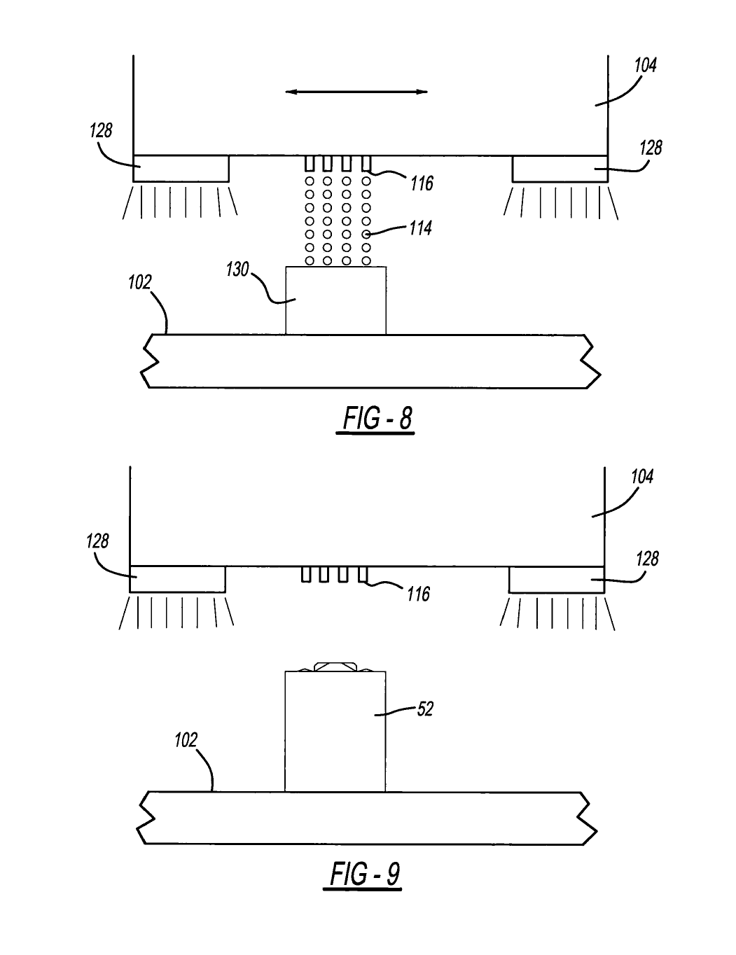

As shown in FIG. 8, head 104 emits subsequent layers 130 of material 114 in multiple passes, upon the already deposited first layer 126, for each of the multiple upper dies 52. Each of the subsequent layers 130 are bound to the preceding layer (e.g., second layer is bound to first layer 126) when cured by lights 128. This layering and curing is repeated many times; for example, repeated for more than fifty layers or head passes, until the plurality of upper dies 52 are fully created.

As should be understood, material 114 is deposited where computer controller 118 informs head 104 that each material formation is desired, but head 104 will not deposit any material 114 where a divet or other open area is present in the CAD drawing of the upper die 52. The material 114 is stacked in many layers, thereby creating the entire upper die 52 as an integral and single piece in a gaseous, particularly air, environment inside an enclosure of machine 100. In other words, each upper die 52 is surrounded by air on all sides, except for first layer 126, which contacts support surface 102 during the entire manufacturing cycle.

After the machine cycle is complete, the user manually removes the manufactured parts from support surface 102, such as by use of a putty knife or other removal tool. Any number of upper dies 52 can be made in a single machine cycle, which is preferably less than ninety minutes. As used herein, manufacturing or machine “cycle” refers to the time period from which head 104 begins depositing first layer 126 of material 114 until when head 104 deposits the final layer of material 114 for the completed part, inclusive of material 114 curing time. In one optional step, each upper die 52 can be further processed by dipping into a hardener, solvent, or final curing solution.

The present three-dimensional printing advantageously builds up multiple upper dies 52 and/or other tooling essentially simultaneously in the same pass, while providing the necessary detail for the die face 58 without machining. For example, all of the dies discussed herein above can be additively printed at the same time on the same 3DP machine. It is noteworthy that, due to the many ink jet printing openings 116 in head 104, each prototype tool or section thereof can be made of a different material deposited essentially simultaneously by head 104. For example, an elastomeric 3DP material can be used as a resilient, impact-absorbing layer between the more rigid stamping surface and the press, with the elastomeric and rigid layers being integrally created as a single, finished die.

Exemplary generic three-dimensional printing machines and materials that can be employed to make tools 52, 54, 70 as specified herein are disclosed in U.S. Patent Publication Nos. 2010/0217429 entitled “Rapid Production Apparatus” which published to Kritchman et al. on Aug. 26, 2010; 2011/0074065 entitled “Ribbon Liquefier for Use in Extrusion-Based Digital Manufacturing Systems” which published to Batchelder et al. on Mar. 31, 2011; and U.S. Pat. No. 7,851,122 entitled “Compositions and Methods for Use in Three Dimensional Model Printing” which issued to Napadensky on Dec. 14, 2010; U.S. Pat. No. 7,369,915 entitled “Device, System and Method for Accurate Printing of Three Dimensional Objects” which issued to Kritchman et al. on May 6, 2008; and U.S. Pat. No. 5,866,058 entitled “Method for Rapid Prototyping of Solid Models” which issued to Batchelder et al. on Feb. 2, 1999. These patent publications and patents are all incorporated by reference herein. A presently preferred machine is the Connex 500 model from Objet Geometries Inc., but may also be a Dimension Elite fused filament fabrication machine from Stratasys, Inc. Nevertheless, it should be appreciated that manufacturing the dies disclosed herein by the present three-dimensional printing steps also disclosed herein is a significant leap in technology.

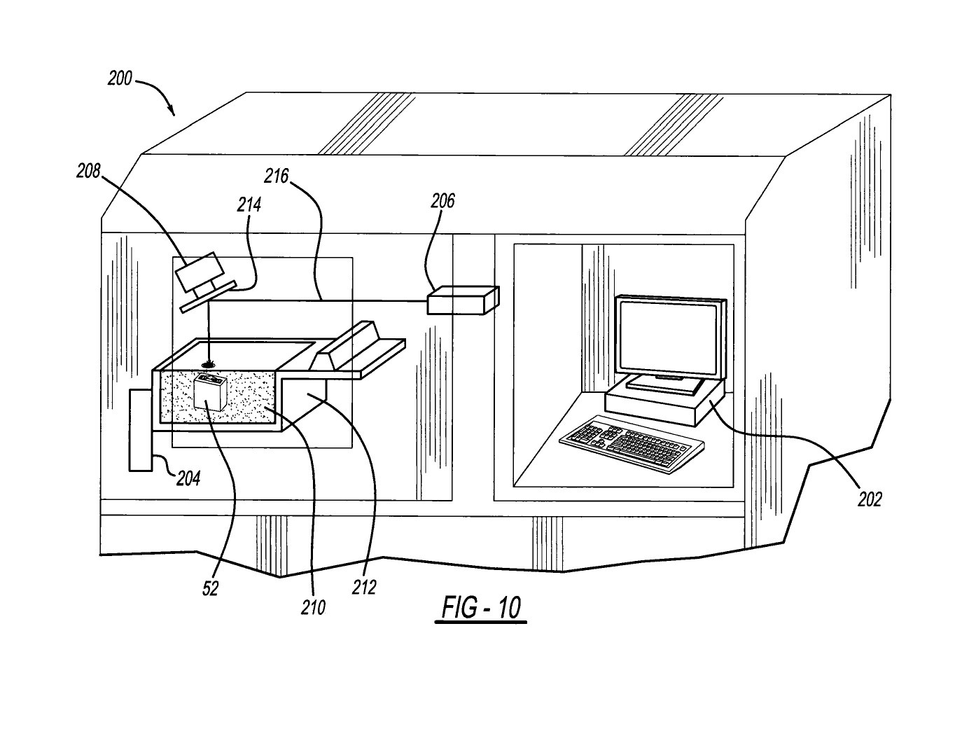

In another embodiment, a direct metal laser sintering machine 200 is shown in FIG. 10. A programmable computer controller 202 controls vertical and horizontal actuators 204, a laser light source 206 and a mirror actuator 208 in accordance with operating software instructions stored within the computer's memory and CAD data for one or more dies (e.g., upper die 52) to be manufactured. Metallic powder 210 is contained within the chamber 212, which is moveable in a three-dimensional manner by actuators 204. A reflective mirror 214 moves a laser light beam 126 emitted from laser 206 such that beam 216 interacts with desired points on the chamber full of metal powder 210. It should also be appreciated that various optics can separate beam 216 into multiple sub-emissions so as to interact with multiple points of metal powder 210 at the same time. This laser-to-powder interaction causes a light curing, or more precisely fusing, of the powder particles at that location such that upper die 52 is built up in a layer-by-layer and additive manner as a single integral part until the entire die is thereby created. The computer can be programmed to essentially simultaneously make multiples of the identical part within the same machine cycle. The upper die 52 is not otherwise contained within specialized and dedicated tooling whereby the direct metal laser sintering machine 200 can make any of the dies disclosed herein with only programming changes.

One suitable machine is the EOSINT M 280 Model which can be obtained from EOS GmbH of Munich. Exemplary generic machines, not known to produce any dies, are disclosed in U.S. Pat. No. 5,658,412 entitled “Method and Apparatus for Producing a Three-Dimensional Object” which issued to Retallick et al. on Aug. 19, 1997; U.S. Patent Publication No. 2009/0017219 entitled “Layer Application Device for an Electrostatic Layer Application of a Building Material in Powder Form and Device and Method for Manufacturing a Three-Dimensional Object” which published to Paasche et al. on Jan. 15, 2009; and U.S. Patent Publication No. 2009/0045553 entitled “Device and Method for a Layerwise Manufacturing of a Three-Dimensional Object from a Building Material in Powder Form” which published to Weidinger et al. on Feb. 19, 2009, all of which are incorporated by reference herein.

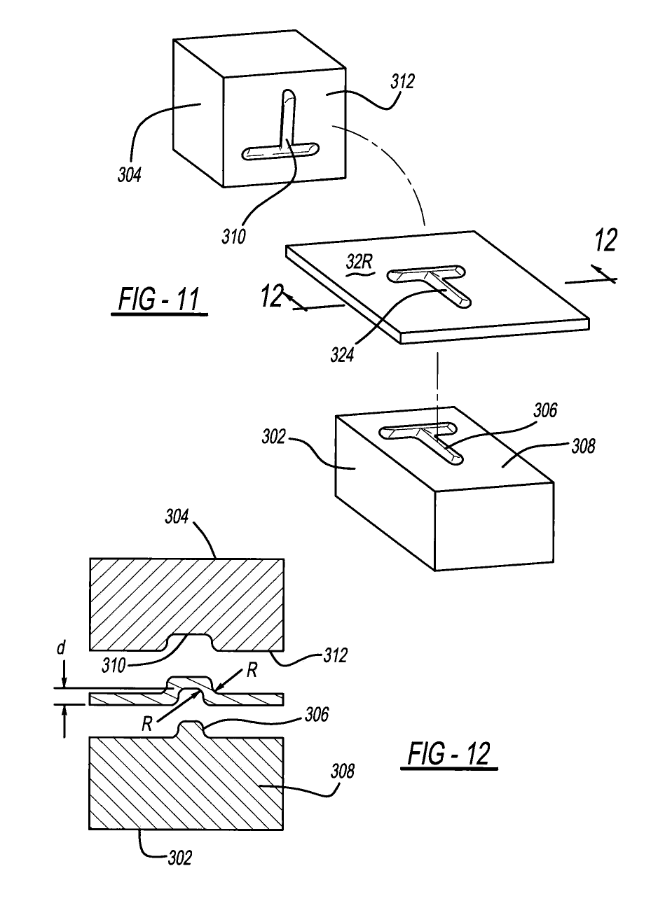

Referring now to FIGS. 11 and 12, male and female tooling dies 302 and 304, respectively are used for embossing. A raised formation 306, here illustrated as a ‘T’, projects from a body 308 of male die 302. Female die 304 includes a corresponding T-shaped recess 310 created below a closing plane 312 thereof. Dies 302 and 304 are made by the layering three-dimensional printing process and polymeric material previously disclosed hereinabove.

A sheet metal blank or workpiece 322 is placed between 3DP dies 302 and 304 after which clamping force is provided to close the dies and emboss an impression 324 onto workpiece 322 corresponding to formation 306 and recess 310. The 3DP tools advantageously create a very crisp and well defined embossed impression 324 due to metal bending, stretching and deformation of workpiece 322. For example, inner and outer radii R equal to half or more of the workpiece thickness, and a draw depth d of at least 1 mm, is achievable with the 3DP prototype dies. This is especially crisp in a workpiece of 0.3 mm (0.012 inch) thick. Moreover, each of the 3DP dies 302 and 304 are automatically manufactured in about 6 hours or less, which is half the time for a traditional steel die, and can be used to make at least 50 and more preferably up to 100 fastener or embossed parts. It should be appreciated that other embossed shapes may be employed, such as circles, ovals, rectangles or text.

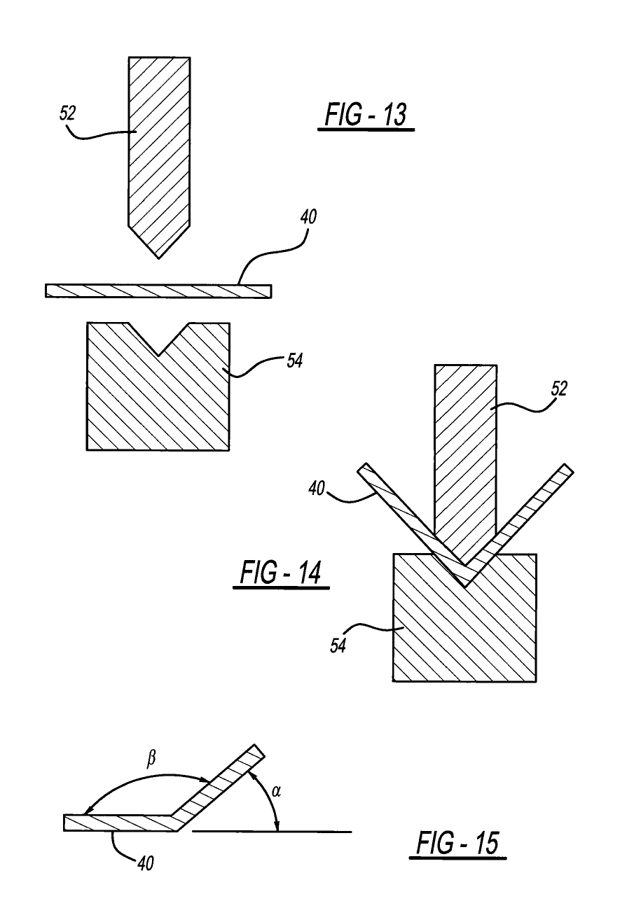

FIGS. 13-15 show a section of 3DP dies 52 and 54 used to create a sharply angled bend in sheet metal blank 40. Exemplary angles ∝ are 22.5, 45, 60, 90 and 135 degrees for blank thickness of 0.012, 0.020, 0.025 and 0.031 inch, respectively. In otherwords, an inside bent angle β is about 157.5° between adjacent bent blank surfaces. The part-to-part tolerance should be plus or minus 1.5° for each of these examples, which is very advantageous compared to traditional non-steel prototype dies.

While various embodiments have been disclosed herein, it should be appreciated that other variations may be employed. For example, tools may be manufactured having alternate die face configurations. It is also envisioned that one or more of the dies for each tool may be manufactured with the three-dimensional printing steps disclosed herein. It should also be realized that while the three step manufacturing process for the trim clip is advantageous, the trim clip may be stamped in more or less steps, although many of the present advantages may not be achieved. Additionally, entirely enclosed hollow voids can be designed and manufactured inside the clamping blocks 56, 60, 74 of the dies 52, 54, 70 in order to save material costs and weight. The number and size of these voids are die specific, in order to guarantee tool integrity. As should be understood, the tools and methods of the present disclosure can advantageously be employed in prototype processing or alternately as tools for bridging production tooling. In other words, the tools and methods of the present disclosure can be used in the interim as production tooling is being manufactured. Nevertheless, such changes, modifications or variations are not to be regarded as a departure from the spirit and scope of the invention.

What is claimed is:

1. A method for manufacturing and/or using a metalworking tool, the method comprising:
(i) depositing a layer of material onto a support surface;
(ii) depositing subsequent layers of the material upon each prior layer until the metalworking tool is completely created;
(iii) curing each subsequent layer to the layer of material deposited therebefore so that the layers of the material bond together;
(iv) creating the metalworking tool to comprise a metal bending face, as part of the depositing steps;
(v) surrounding at least a majority of the metalworking tool with a gas during the depositing and creating steps; and
(vi) removing the completed metalworking tool from the support surface.

2. The method of claim 1, further comprising:
using the metalworking tool to create a metallic part therefrom.

3. The method of claim 2, wherein using the metalworking tool further comprises:
(a) placing a metallic part on the metal bending face of the metalworking tool; and
(b) bending the metallic part against the metal bending face of the metalworking tool.

4. The method of claim 3, wherein bending the metallic part against the metal bending face of the metalworking tool includes stamping the metallic part between a pair of metalworking tools.

5. The method of claim 1, wherein forming the metalworking tool further comprises:
flowing the material from a head positioned above the support surface, wherein at least one of the head and the support surface automatically moves relative to the other according to computer instructions in order to create identical multiples of the metalworking tool in the same machine cycle.

6. The method of claim 5, wherein the machine cycle is less than ninety minutes.

7. The method of claim 1, wherein the material is a three-dimensionally printable and light curable polymer.

8. The method of claim 1, wherein the material is a polymeric string emitted in a continuous manner from a spool which supplies the polymeric string to a head for depositing the layer of material onto the support surface.

9. The method of claim 1, further comprising before depositing the layer of material onto the support surface:
flowing the material from an ink jet printing head including openings arranged in a linear array such that multiple material flows simultaneously occur for each layer.

10. The method of claim 1, wherein the material is metal.

11. The method of claim 1, wherein the depositing occurs during one of direct metal laser sintering, fused filament fabrication, selective laser sintering, electron beam melting, and direct laser sintering.

12. The method of claim 1, further comprising creating a fastener stamping formation or recess on a working face of the tool which is a die entirely made of a three-dimensionally printed polymer.

13. The method of claim 1, wherein the tool is a metal embossing tool with an embossing formation or recess made of a three-dimensionally printed polymer.

14. The method of claim 1, wherein the tool is adapted for creating an angle of less than 158° between adjacent bent surfaces of a sheet metal fastener having a thickness of about 0.3 mm (0.012 inch).

15. The method of claim 1, wherein the tool is adapted for bending a radius of ½ of a fastener blank thickness.

16. A method for manufacturing and using a tool, the method comprising:
creating a die with a three-dimensional printing process, the die having a die face corresponding to a surface of a part;
arranging a blank on the die face; and
bending the blank against the die face.

17. The method of claim 16, further comprising:
creating a second die with the three-dimensional printing process, the second die having a second die face corresponding to a second surface of the part, wherein bending the blank against the die face includes stamping the blank between the die face and the second die face.

18. The method of claim 17, further comprising:
creating a third die from a metal, the third die having a third die face;
creating a fourth die from the three-dimensional printing process, the fourth die having a fourth die face defining a channel;
arranging the blank on the fourth die; and
bending the blank into the channel of the fourth die face with the third die face.

19. The method of claim 16, wherein forming the die from the three-dimensional printing process further comprises:
flowing a material from a head positioned above a support surface, wherein at least one of the head and the support surface automatically moves relative to the other according to computer instructions in order to create identical multiples of the die in the same machine cycle.

20. The method of claim 19, wherein the machine cycle is less than ninety minutes.

21. The method of claim 16, wherein the die is made from a three-dimensionally printable polymer.

22. The method of claim 21, wherein the material is a polymeric string emitted in a continuous manner from a spool which supplies the polymeric string to the head.

23. The method of claim 16, wherein forming the die from the three-dimensional printing process further comprises:
(a) depositing a layer of material onto a support surface;
(b) depositing subsequent layers of the material upon each prior layer until at least one of the die is completely created;
(c) curing each subsequent layer to the layer of material deposited therebefore so that the layers of the material bond together;
(d) creating the at least one die to comprise the die face, as part of the depositing steps;
(e) surrounding at least a majority of the at least one die with a gas during the depositing and creating steps; and
(f) removing the completed at least one die from the support surface.

24. The method of claim 23, further comprising:
flowing a material from an ink jet printing head including openings arranged in a linear array such that multiple material flows simultaneously occur for each layer.

25. The method of claim 16, further comprising making at least 50 sheet metal fasteners with the three-dimensionally printed die.

26. The method of claim 16, further comprising embossing at least 50 of the blanks with the three-dimensionally printed die.

27. A method for forming a 3DP die set for stamping a metallic fastener, the method comprising:
using at least one ink jet printer opening to emit at least one three-dimensionally printable material to create a first die member of the 3DP die set, the first die member defining a first die face; and
using the at least one ink jet printer opening to emit the at least one three-dimensionally printable material to create a second die member of the 3DP die set, the second die member defining a second die face opposingly mating with the first die face.

28. The method of claim 27, further comprising:
flowing the three-dimensionally printable material from a head positioned above a support surface, at least one of the head and the support surface automatically moving relative to the other according to computer instructions in order to create multiples of one of the first and second die members in the same manufacturing cycle.

29. The method of claim 27, further comprising:
flowing the three-dimensionally printable material on top of a stationary machine support surface, on a layer by layer basis.

30. The method of claim 27, wherein the three-dimensionally printable material is a polymeric string supplied to the ink jet printer opening by a spool.

31. The method of claim 27, further comprising curing the three-dimensionally printable material with light as the three-dimensionally printable material is built up to create one of the first and second die members.

32. A metal-stamping device comprising a metal-stamping die including a three-dimensionally printable material.

33. A metal-stamping apparatus comprising:
a first die member having a first die face, the first die member additively layered;
a second die member having a second die face, the second die member additively layered, wherein the first and second die members are additively layered from one of a three-dimensionally printable material, a direct metal laser sintering material, a fused filament fabrication material, a selective laser sintering material, an electron beam melting material, and a direct laser sintering material; and
a press having a first device for securing the first die member and a second device for securing the second die member, wherein the first and second die faces are offset and opposed by the press.
